(19) United States
(12) Patent Application Publication
(10) Pub. No.: US 2007/0164972 A1
(43) Pub. Date: Jul. 19, 2007

(54) Liquid crystal display and method of repairing the same

(75) Inventor: Jong-woong Chang, Cheonan-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/543,959

(22) Filed: Oct. 4, 2006

(30) Foreign Application Priority Data
Jan. 18, 2006 (KR) 10-2006-0005484

(51) Int. Cl. G09G 3/36

(52) U.S. Cl. 345/100

(57) ABSTRACT

A liquid crystal display (LCD) having a working and a redundant shift register for driving the gate lines of the display. A plurality of repair lines RL1-RLn run in parallel with the plurality of gate lines GL1-GLn between the working shift register whose stages are arranged to one side of the display and the redundant shift register whose stages are arranged on the opposite side of the display. Initially the repair lines are not connected to either of the shift registers and the gate lines are only connected to the outputs of the working shift register. Both the working and the redundant shift register are connected to receive the same input driving signals. When a defect is discovered in the working shift register, a laser beam is used to disconnect the output of the defective shift register stage from its gate line. A laser beam is then used to connect end of the repair line to receive the input signal for the defective stage and connect the other end of the repair line to deliver the input signal to the input terminal of the corresponding stage of the redundant shift register. The output terminal of the corresponding stage of the redundant shift register is connected to normally unconnected end of the gate line from the defective stage so as to deliver output to the stage of working register following the defective stage.

### CROSS-REFERENCE TO RELATED APPLICATION

This application claims priority from Korean Patent Application No. 10-2006-0005484 filed on Jan. 18, 2006 in the Korean Intellectual Property Office, the disclosure of which is incorporated herein by reference in its entirety.

1. Field of the Invention

The present invention relates to a display device and a method of repairing the same, and more particularly, to a liquid crystal display (LCD) and a method of repairing the same.

2. Background of the Related Art

A display device generally includes a display panel, a gate driving circuit for driving the display panel, and a source driving circuit that outputs an image signal to the display panel. The gate driving circuit and the source driving circuit may be mounted in the display panel in the form of a tape carrier package (TCP) or a chip on glass (COG). The gate driving circuit may be formed directly in the display panel. Such a structure in which the gate driving circuit is formed directly in the display panel includes a shift register having multiple stages cascade-connected with one another. The gate driving circuit according to the prior art is formed directly on the display panel that has a plurality of amorphous-silicon thin film transistors (hereinafter sometimes referred to as a-Si TFTs). If a defect occurs in any of the a-Si TFTs during manufacture of the TFTs, the presence of the defect can be recognized by testing the completed display panel. However, when a defect occurs in the gate driving circuit, it is not easy to repair the gate driving circuit because the gate driving circuit is formed directly on the display panel.

### SUMMARY OF THE INVENTION

The present invention provides a liquid crystal display (LCD) having a working and a redundant shift register for driving the gate lines of the display. A plurality of repair lines RL1-RLn run in parallel with the plurality of gate lines GL1-GLn between the working shift register whose stages are arranged to one side of the display and the redundant shift register whose stages are arranged on the opposite side of the display. Initially the repair lines are not connected to either of the shift registers and the gate lines are only connected to the outputs of the working shift register. Both the working and the redundant shift register are connected to receive the same input driving signals. When a defect is discovered in the working shift register, a laser beam is used to disconnect the output of the defective shift register stage from its gate line. A laser beam is then used to connect end of the repair line to receive the input signal for the defective stage and connect the other end of the repair line to deliver the input signal to the input terminal of the corresponding stage of the redundant shift register. The output terminal of the corresponding stage of the redundant shift register is connected to normally unconnected end of the gate line from the defective stage so as to deliver output to the stage of working register following the defective stage.

### BRIEF DESCRIPTION OF THE DRAWINGS

The above and other features and advantages of the present invention will become more apparent by describing in detail an exemplary embodiment thereof with reference to the attached drawings in which:

FIG. 1 is a plane view of a liquid crystal display (LCD) according to an embodiment of the present invention;

FIG. 2A is a block diagram of a first gate driving circuit and a second gate driving circuit of FIG. 1;

FIG. 2B shows another example of FIG. 2A; and

FIG. 3 is a block diagram explaining the method of repairing the first gate driving circuit and the second gate driving circuit of FIG. 1.

### DETAILED DESCRIPTION OF THE INVENTION

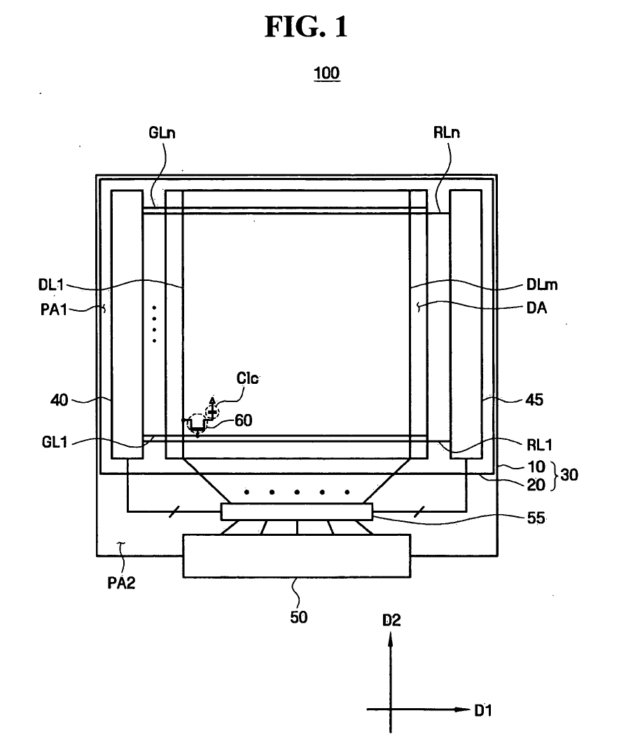

Throughout the specification, like reference numerals refer to like elements. Referring to the plan view of a liquid crystal display shown in FIG. 1, LCD 100 includes an LCD panel 30 comprised of a first substrate 10, a second substrate 20 facing the first substrate 10, and a liquid crystal layer (not shown) interposed between the first substrate and the second substrate. LCD panel 30 includes a display region DA that displays an image and a first peripheral area PA1 and a second peripheral area PA2 that are adjacent to the display region DA. In the display region DA, a plurality of gate lines GL1-GLn extend in a first direction D1 and a plurality of data lines DL1-DLm extend in a second direction D2 transverse to the first direction D1. Pixel regions are formed in a matrix defined by the intersection gate lines and data lines.

In the display region DA, a plurality of repairing lines RL1-RLn are formed in parallel with the plurality of gate lines GL1-GLn. Each of the pixel regions includes a thin film transistor (TFT) 60 and a liquid crystal capacitor C1c connected thereto. In TFT 60, a gate electrode is connected to a corresponding gate line, a source electrode is connected to a corresponding data line, and a drain electrode is connected to the liquid crystal capacitor C1c.

A first gate driving circuit 40 for sequentially outputting a gate driving signal to the plurality of gate lines GL1-GLn is formed on the left area of the first peripheral area PA1, which is adjacent to the left end of the plurality of gate lines GL1-GLn. A second gate driving circuit 45 is formed on the right-hand area of the first peripheral area PA1as a redundancy circuit for driving first gate driving circuit 40 via the right-hand end of the plurality of gate lines GL1-GLn. In other words, the first gate driving circuit 40 and the second gate driving circuit 45 are arranged symmetrically in areas of the first peripheral area PA1 located to the left and right of the display region DA.

The second peripheral area PA2 is adjacent to one end of the plurality of data lines DL1-DLm. A data line driving chip 55 mounted on the second peripheral area PA2 provides an image signal to the plurality of data lines DL1-DLm. A flexible printed circuit board 50 is attached to one side of the second peripheral area PA2 and serves to electrically connect an external device (not shown) for driving the LCD panel 30. The flexible printed circuit board 50 is electrically connected with the data driving chip 55. The first gate driving circuit 40 and the second driving circuit 45 may be connected to the flexible printed circuit board 50 through the data driving chip 55 or connected directly to the flexible printed circuit board 50.

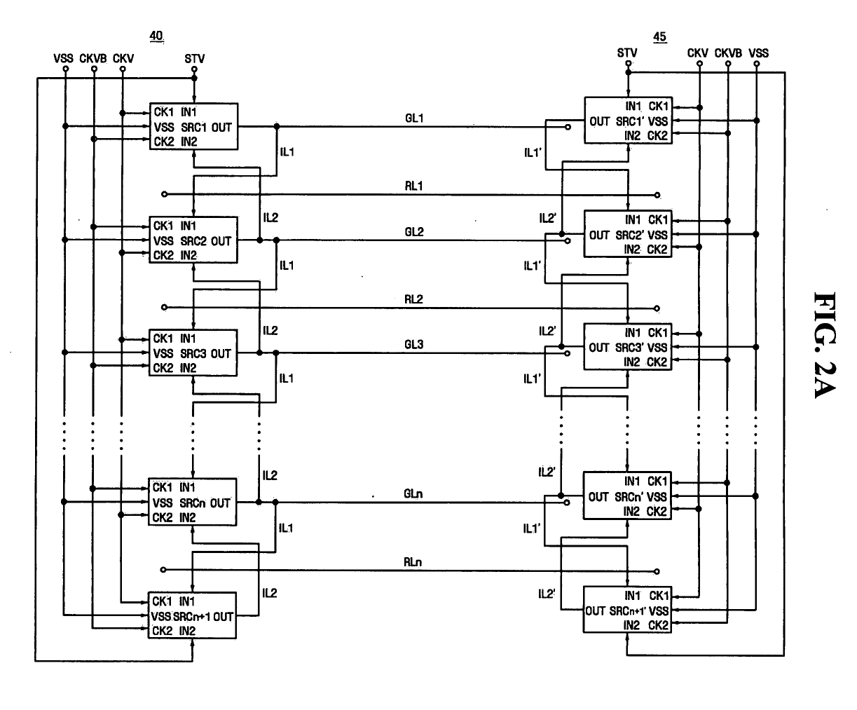

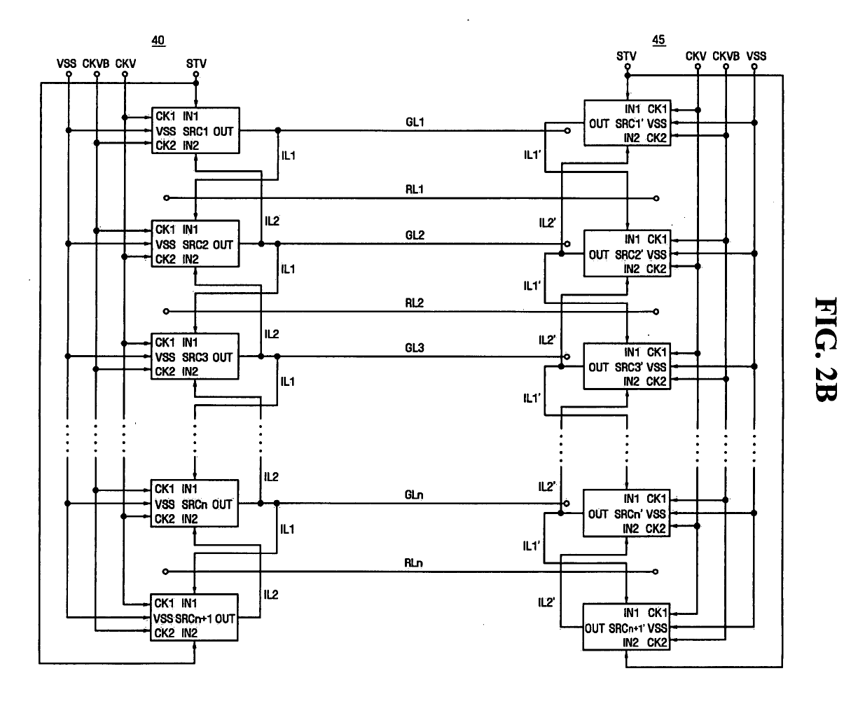

FIG. 2A is a block diagram of a first gate driving circuit 40 and a second gate driving circuit 45 of FIG. 1 according to an embodiment of the present invention. Referring to FIG. 2A, the first gate driving circuit 40 includes a shift register comprised of a plurality of stages SRC1-SCRn+1 cascade-connected with one another. In other words, the first gate driving circuit 40 includes first through n^{th} stages SRC1-SRCn for outputting a gate signal (or scan signal) to n gate lines GL1-GLn and a “dummy” stage SRCn+1 which does not drive one of the gate lines but merely provides a control signal to a previous stage.

Each of the stages SRC1-SCRn+1 includes a first clock terminal CK1, a second clock terminal CK2, a first input terminal IN1, a second input terminal IN2, an output terminal OUT, and a ground voltage terminal VSS. The first clock signal CKV is provided to the first clock terminal CK1 of each of the odd-numbered stages SRC1, SRC3, . . . , SRCn+1 and a second clock signal CKVB having an inverted phase to the first clock signal CKV is provided to the first clock terminal CK1 of each of even-numbered stages SRC2, SRC4, . . . , SRCn. The second clock signal CKVB is provided to the second clock terminal CK2 of each of the odd-numbered stages SRC1, SRC3, . . . , SRCn+1 and the first clock signal CKV is provided to the second clock terminal CK2 of each of the even-numbered stages SRC2, SRC4, . . . , SRCn.

The output terminal OUT of each of the odd-numbered stages SRC1, SRC3, . . . , SRCn+1 outputs the first clock signal CKV and the output terminal OUT of each of the even-numbered stages SRC2, SRC4, . . . , SRCn outputs the second clock signal CKVB. The output terminal OUT of each of the n stages SRC1-SRCn is electrically connected to each of the corresponding gate lines GL1-GLn included in the display region (DA of FIG. 1). Thus, the shift register sequentially drives the n gate lines GL1-GLn.

A signal output from the output terminal OUT of a previous stage is input to the first input terminal IN1 and a signal output from the output terminal of a next stage is input to the second input terminal IN2. However, a scan trigger signal STV, instead of a signal output from a previous stage, is provided to the first input terminal IN1 of the first stage SRC1. In addition, the scan trigger signal STV, instead of a signal output from a next stage, is provided to the second input terminal IN2 of the (n+1)^{th} stage SRCn+1, which outputs its output signal to the second input terminal IN2 of the n^{th} stage SRCn.

Hereinafter, the structure and operation of each of the stages SRC1-SRCn+1 will be described. As mentioned above, each of the stages SRC1-SRCn+1 includes the first clock terminal CK1, the second clock terminal CK2, the first input terminal IN1, the second input terminal IN2, the output terminal OUT, and the ground voltage terminal VSS. Here, the first input terminal IN1 is connected to the output terminal OUT of a previous stage through a first input line IL1, the second input terminal IN2 is connected to the output terminal OUT of a next stage through a second input line IL2, the output terminal OUT of each of the stages SRC1-SRCn are connected to the plurality of gate lines GL1-GLn, respectively, and a ground voltage VSS is input to the ground voltage terminal VSS.

More specifically, the first stage SRC1 receives the first clock signal CKV externally supplied through the first clock terminal CK1, the second clock signal CKVB externally supplied through the second clock terminal CK2, the scan trigger signal STV through the first input terminal IN1, and a second gate signal GOUT2, which is provided from the second stage SRC2 via the second input line IL2, through the second input terminal IN2 and outputs a first gate signal GOUT1 for selecting the first gate line GL1 through the output terminal OUT. The first gate signal GOUT1 is also output to the first input terminal IN1 of the second stage SRC2 via the first input line IL1.

The second stage SRC2 receives the second clock signal CKVB externally supplied through the first clock terminal CK1, the first clock signal CKV externally supplied through the second clock terminal CK2, the first gate signal GOUT1, which is provided from the first stage SRC1 via the first input line IL1, through the first input terminal IN1, and a third gate signal GOUT3, which is provided from the third stage SRC3 via the second input line IL2, through the second input terminal IN2, and outputs the second gate signal GOUT2 for selecting the second gate line GL2 through the output terminal OUT.

The second gate signal GOUT2 is also output to the first input terminal IN1 of the third stage SRC3 via the first input line IL1. Similarly, the n^{th} stage SRCn receives the second clock signal CKVB externally supplied through the first clock terminal CK1, the first clock signal CKV externally supplied through the second clock terminal CK2, an (n−1)^{th} gate signal GOUTn−1, which is provided from the (n−1)^{th} stage SRCn−1 via the first input line IL1, through the first input terminal IN1, and a (n+1)^{th} gate signal GOUTn+1, which is provided from the (n+1)^{th} stage SRCn+1 via the second input line IL2, through the second input terminal IN2, and outputs an nth gate signal GOUTn for selecting the n^{th} gate line GLn through the output terminal OUT. The n^{th} gate signal GOUTn is also output to the first input terminal IN1 of the dummy stage SRCn+1 via the first input line IL1.

Referring to FIG. 2A, the first gate driving circuit 40 and the second gate driving circuit 45 are symmetrically arranged to the left and right of the display region in which the plurality of gate lines GL1-GLn are formed. In other words, the second gate driving circuit 45 includes another shift register having a plurality of stages SRC1′-SCRn+1′ cascade-connected with one another. That is to say, the second gate driving circuit 45 includes first through n^{th} stages SRC1′-SCRn+1′ for outputting a gate signal (or scan signal) and a “dummy” stage SRCn+1′ whose output does not drive on of gate lines but instead merely provides a control signal to a previous stage.

Like each of the stages SRC1-SRCn+1 of the first gate driving circuit 40, each of the stages SRC1′-SCRn+1′ includes a first clock terminal CK1, a second clock terminal CK2, a first input terminal IN1, a second input terminal IN2, an output terminal OUT, and a ground voltage terminal VSS. The signals CKV, CKVB, VSS, and STV, which are the same as in the first gate driving circuit 40, are provided to the second gate driving circuit 45. The second gate driving circuit 45 has similar structure to that of the first gate driving circuit except that the output terminal OUT of each of the stages SRC1′-SCRn+1′ is not electrically connected to any of the plurality of gate lines GL1-GLn, respectively.

It is preferable that a first input line IL1′ or a second input line IL2′ connected to the output terminal OUT of each of the stages SRC1′-SCRn+1′ be arranged to overlap with the plurality of gate lines GL1-GLn, respectively, in order to connect the plurality of gate lines GL1-GLn and the first input lines IL1′ or the second input lines IL2′ of the stages SRC1′-SCRn+1′. Although the invention is described with regard to an example in which the plurality of gate lines GL1-GLn overlap with the first input lines IL1′ as shown in FIG. 2A, the present invention is not limited thereto and the plurality of gate lines GL1-GLn may overlap with lines connected to the output terminal OUT of each of the stages SRC1′- SCRn+1′.

For example, as shown in FIG. 2B, the plurality of gate lines GL1-GLn may overlap with the second input lines IL2′. FIG. 2B shows a modified example of FIG. 2A. Hereinafter, the present invention will be described with reference to FIG. 2A for brevity.

As shown in FIG. 2A, the plurality of repairing lines RL1-RLn are arranged in parallel with the plurality of gate lines GL1-GLn and are electrically disconnected from other lines, e.g., the plurality of gate lines GL1-GLn, the first input lines IL1, the second input lines IL2, the first input lines IL1′, and the second input lines IL2′. The plurality of repairing lines RL1-RLn may be arranged to correspond respectively to the plurality of stages of the first gate driving circuit 40 and the second gate driving circuit 45. It is preferable that the plurality of repairing lines RL1-RLn overlap with the input lines IL1 and IL2 of the stages SRC1-SRCn+1, respectively, and with the input lines IL1′ and IL2′ of the stages SRC1′-SCRn+1′, respectively.

In this way, the first gate driving circuit 40 is connected directly to the plurality of gate lines GL1-GLn to sequentially output a gate driving signal, and the second gate driving circuit 45 is not connected directly to the plurality of gate lines GL1-GLn, but is used, together with the plurality of repairing lines RL1-RLn, as a redundancy circuit for the first gate driving circuit 40 to repair the LCD when a defect occurs in the first gate driving circuit 40.

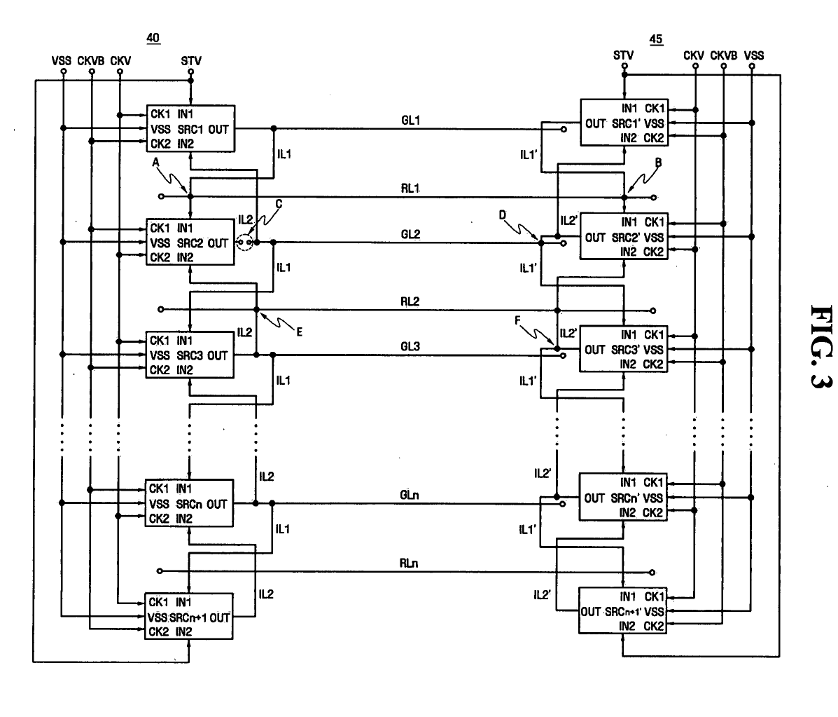

Hereinafter, the repairing method of the liquid crystal display device will be described with reference to FIGS. 1A and 3 in detail. FIG. 3 is a block diagram for explaining a method of repairing the first gate driving circuit and the second gate driving circuit of FIG. 1.

In general, in a structure where a gate driving circuit is formed directly on an LCD panel using a plurality of amorphous-silicon thin film transistors (a-Si TFTs), it is difficult to repair an LCD when a defect occurs in the gate driving circuit. However, by symmetrically arranging the first gate driving circuit 40 and the second gate driving circuit 45 in areas of the first peripheral area PA1 located to the left and right of the display region DA of the LCD panel 30 and forming the plurality of repairing lines RL1-RLn in parallel with the plurality of gate lines GL1-GLn, the LCD 100 can be easily repaired.

For example, when a defect occurs in the second stage SRC2 of the first gate driving circuit 40, the LCD 100 is repaired as follows. As shown in FIG. 3, the first repairing line RL1 arranged between the second stage SRC2 having a defect and the first stage SRC1 intersects the first input line IL1 that connects the first input terminal IN1 of the second stage SRC2 with the output terminal OUT of the first stage SRC1 and intersects the first input line IL1′ that connects the first input terminal IN1 of the second stage SRC2′ with the output terminal OUT of the first stage SRC1. Here, an intersection “A” short-circuits the first repairing line RL1 and the first input line IL1 of the second stage SRC2 from each other using a laser beam, and an intersection “B” short-circuits the first repairing line RL1 and the first input line IL1′ of the second stage SRC2′ from each other. The intersections “A” and “B” perform short-circuiting using a laser beam.

A spot “C” connecting the second gate line GL2 and the output terminal OUT of the second stage SRC2 is open-circuited using a laser beam. Here, it is preferable that the spot “C” be positioned between a node connecting the second gate line GL2 and the first input line IL1 and the output terminal OUT and between a node connecting the second gate line GL2 and the second input line IL2 and the output terminal OUT.

The second gate line GL2 is electrically disconnected from and intersects a line connected to the output terminal OUT of the second stage SRC2′. The line connected to the output terminal OUT of the second stage SRC2′ may be the second input line IL2′ that connects the output terminal OUT of the second stage SRC2′ with the second input terminal IN2 of the first stage SRC1′ or the first input line IL1′ that connects the output terminal OUT of the second stage SRC2′ with the first input terminal IN1 of the third stage SRC3′.

An intersection “D” short-circuits the line connected to the output terminal OUT of the second stage SRC2′ and the second gate line GL2 from each other using a laser beam.

The second repairing line RL2 arranged between the second stage SRC2 and the third stage SRC3 intersects the second input line IL2 that connects the second input terminal IN2 of the second stage SRC2 with the output terminal OUT of the third stage SRC3 and intersects the second input line IL2′ that connects the second input terminal IN2 of the second stage SRC2′ with the output terminal OUT of the third stage SRC3′. Here, an intersection “E” connecting the second repairing line RL2 and the second input line IL2 of the second stage SRC2 and a intersection “F” connected the second repairing line RL2 and the second input line IL2′ of the second stage SRC2′ from each other using a laser beam.

The repaired LCD operates as follows. The second stage SRC2′ of the second gate driving circuit 45 operates instead of the defective second stage SRC2 of the first gate driving circuit 40. Thus, the first gate signal GOUT1 output from the first stage SRC1 is provided to the first input terminal IN1 of the second stage SRC2′ from the output terminal OUT of the first stage SRC1 via the first input line IL1, the intersection “A”, the first repairing line RL1, the intersection “B”, and the first input line IL1′.

The second gate signal GOUT2 output from the second stage SRC2′ is provided to the first input terminal IN1 of the third stage SRC3 from the output terminal OUT of the second stage SRC2′ via the first input line IL1′, the intersection “D”, the second gate line GL2, and the first input line IL1. The third gate signal GOUT3 output from the third stage SRC3 is provided to the second input terminal IN2 of the second stage SRC2′ from the output terminal OUT of the third stage SRC3 via the second input line IL2, the intersection “E”, the second repairing line RL2, the intersection “F”, and the second input line IL2′.

As such, the second stage SRC2′ receives the first clock signal CKV externally supplied through the first clock terminal CK1, the second clock signal CKVB externally supplied through the second clock terminal CK2, the first gate signal GOUT1, which is provided from the first stage SRC1 via the first repairing line RL1, through the first input terminal IN1, and the third gate signal GOUT3, which is provided from the third stage SRC3 via the second repairing line RL2, through the second input terminal IN2, and outputs the second gate signal GOUT2 for selecting the second gate line GL2 through the output terminal OUT. The second gate signal GOUT2 is also output to the first input terminal IN1 of the third stage SRC3 through the first input line IL1. In this way, a separate current path going round a stage having a defect is formed using the plurality of repairing lines RL1-RLn, thereby easily repairing a defect of a gate driving circuit.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, it is to be understood that the above-described embodiments have been provided only in a descriptive sense and will not be construed as placing any limitation on the scope of the invention.

What is claimed is:

1. A liquid crystal display (LCD) comprising:
first through third gate lines;
a first gate driving circuit including first through third stages which are arranged on a first side of the first through third gate lines, respectively, and supply an output signal for sequentially selecting the first through third gate lines;
a second gate driving circuit including first through third stages which are arranged on a second side of the first through third gate lines, respectively, and supply an output signal for sequentially selecting the first through third gate lines; and
a first repairing line including a first end and a second end, the first end intersecting an input line that connects a first input terminal of the second stage for the first gate driving circuit with an output terminal of the first stage for the first gate driving circuit, and the second end intersecting an input line that connects a first input terminal of the second stage for the second gate driving circuit with an output terminal of the first stage for the second gate driving circuit,
wherein output terminals of the first through third stages for the first gate driving circuit are connected to the first side of the first through third gate lines, respectively, and a line connected to an output terminal of the second stage for the second gate driving circuit is electrically disconnected from and intersects the second gate line.

2. The LCD of claim 1, further comprising a second repairing line including a first end and a second end, the first end being electrically disconnected from and intersecting an input line that connects a second input terminal of the second stage for the first gate driving circuit with the output terminal of the third stage for the first gate driving circuit, and the second end being electrically disconnected from and intersecting an input line that connects a second input terminal of the second stage for the second gate driving circuit with an output terminal of the third stage for the second gate driving circuit.

3. The LCD of claim 1, wherein the line connected to the output terminal of the second stage for the second gate driving circuit is an input line that connects the output terminal of the second stage for the second gate driving circuit with a second input terminal of the first stage for the second gate driving circuit.

4. The LCD of claim 1, wherein the line connected to the output terminal of the second stage for the second gate driving circuit is an input line that connects the output terminal of the second stage for the second gate driving circuit with a first input terminal of the third stage for the second gate driving circuit.

5. The LCD of claim 1, wherein each of the first through third stages includes a first clock terminal supplied with a first clock signal, a second clock terminal supplied with a second clock signal having an inverted phase to the first clock signal, a first input terminal supplied with an output signal of a previous stage, a second input terminal supplied with an output signal of a next stage, and a ground voltage terminal supplied with a ground voltage.

6. A liquid crystal display (LCD) comprising:
first through third gate lines;
a first gate driving circuit including first through third stages which are arranged on a first side of the first through third gate lines, respectively, and supply an output signal for sequentially selecting the first through third gate lines;
a second gate driving circuit including first through third stages which are arranged on a second side of the first through third gate lines, respectively, and supply an output signal for sequentially selecting the first through third gate lines; and
a first repairing line including a first end and a second end, the first end short-circuited from an input line that connects a first input terminal of the second stage for the first gate driving circuit with an output terminal of the first stage for the first gate driving circuit, and the second end short-circuited from an input line that connects a first input terminal of the second stage for the second gate driving circuit with an output terminal of the first stage for the second gate driving circuit,
wherein output terminals of the first and third stages for the first gate driving circuit are connected to the first side of the first and third gate lines, respectively, the output terminal of the second stage for the first gate driving circuit is open-circuited from the first side of the second gate line, and the output terminal of the second stage for the second gate driving circuit is short-circuited from the second side of the second gate line.

7. The LCD of claim 6, further comprising a second repairing line including a first end and a second end, the first end being short-circuited from an input line that connects a second input terminal of the second stage for the first gate driving circuit with the output terminal of the third stage for the first gate driving circuit, and the second end being short-circuited from an input line that connects a second input terminal of the second stage for the second gate driving circuit with an output terminal of the third stage for the second gate driving circuit.

8. The LCD of claim 6, wherein the second gate line is short-circuited from an input line that connects the output terminal of the second stage for the second gate driving circuit with the second input terminal of the first stage for the second gate driving circuit.

9. The LCD of claim 6, wherein the second gate line is short-circuited from an input line that connects the output terminal of the second stage for the second gate driving circuit with a first input terminal of the third stage for the second gate driving circuit.

10. The LCD of claim 6, wherein the second gate line is connected to a second input terminal of the first stage for the first gate driving circuit.

11. The LCD of claim 6, wherein the second gate line is connected to a first input terminal of the third stage for the first gate driving circuit.

12. The LCD of claim 6, wherein each of the first through third stages includes a first clock terminal supplied with a first clock signal, a second clock terminal supplied with a second clock signal having an inverted phase to the first clock signal, a first terminal supplied with an output signal of a previous stage, a second input terminal supplied with an output signal of a next stage, and a ground voltage terminal supplied with a ground voltage.

13. A liquid crystal display (LCD) comprising:
an LCD panel having a plurality of gate lines arranged thereon;
a first gate driving circuit having a shift register including a plurality of stages which are arranged on a first side of the plurality of gate lines arranged on the LCD panel and are electrically connected on the first side of the plurality of gate lines, respectively;
a second gate driving circuit having a shift register including a plurality of stages which are arranged on a second side of the plurality of gate lines arranged on the LCD panel and are electrically disconnected from the plurality of gate lines; and
a repairing line that includes a first end disposed between two adjacent stages of the first gate driving circuit and a second end disposed between two adjacent stages of the second gate driving circuit, the repairing line being electrically disconnected from the first gate driving circuit and the second gate driving circuit.

14. The LCD of claim 13, wherein the repairing line is electrically disconnected from and intersects a first input terminal that connects a first input terminal of the rear stage of the two adjacent stages with an output terminal of the front stage of the two adjacent stages.

15. The LCD of claim 13, wherein the repairing line is electrically disconnected from and intersects a second input line that connects a second input terminal of the front stage of the two adjacent stages with an output terminal of the rear stage of the two adjacent stages.

16. The LCD of claim 13, wherein a line connected to the output terminal of the stage of the second driving circuit is electrically disconnected from and intersects the second end of the gate line.

17. The LCD of claim 13, wherein each of the first through third stages includes a first clock terminal supplied with a first clock signal, a second clock terminal supplied with a second clock signal having an inverted phase to the first clock signal, a first input terminal supplied with an output signal of a previous stage, a second input terminal supplied with an output signal of a next stage, and a ground voltage terminal supplied with a ground voltage.

18. A method of repairing a liquid crystal display (LCD), the method comprising:
preparing the LCD of claim 1;
short-circuiting the first repairing line with an input line that connects a first input terminal of the second stage for the first gate driving circuit with an output terminal of the first stage for the first gate driving circuit, and an input line that connects a first input terminal of the second stage for the second gate driving circuit with an output terminal of the first stage for the second gate driving circuit, respectively, using a laser beam; and
short-circuiting the second gate line with a line connected to an output terminal of the second stage for the second gate driving circuit using a laser beam.

19. The method of claim 18, further comprising short-circuiting the second gate line with a portion that connects an output terminal of the second stage for the first gate driving circuit using a laser beam.

20. The method of claim 18, further comprising:
forming a second repairing line including a first end and a second end, the first end being electrically disconnected from and intersecting an input line that connects a second input terminal of the second stage for the first gate driving circuit with the output terminal of the third stage for the first gate driving circuit, and the second end being electrically disconnected from and intersecting an input line that connects a second input terminal of the second stage for the second gate driving circuit with an output terminal of the third stage for the second gate driving circuit; and
short-circuiting the second repairing line with an input line that connects a second input terminal of the second stage for the first gate driving circuit with an output terminal of the third stage for the first gate driving circuit, and an input line that connects a second input terminal of the second stage for the second gate driving circuit with an output terminal of the third stage for the second gate driving circuit, respectively, using a laser beam.
